(19) United States
(12) Patent Application Publication
(10) Pub. No.: US 2026/0228079 A1
(43) Pub. Date: Aug. 6, 2026

(54) User Specific Root Cause Analysis Generation

(71) Applicant: Dell Products L.P., Round Rock, TX (US)

(72) Inventors: Ophir Buchman, Raanana (IL); Yevgeni Gehtman, Modi'in (IL); Omer Aharony, Newton, MA (US)

(21) Appl. No.: 19/046,274

(22) Filed: Feb. 5, 2025

(51) Int. Cl. G06F 11/07; G06F 11/3604; G06N 5/022

(52) U.S. Cl. CPC G06F 11/079; G06F 11/3612; G06N 5/022

(57) ABSTRACT

A system can determine a resolution to an issue with a computing device. The system can, based on the determining of the resolution and a root cause analysis document template, process data relevant to the resolution to the issue with the computing device with natural language processing, to produce a root cause analysis document. The system can store the root cause analysis document. The system can update a second document based on the root cause analysis document, wherein the second document differs from the root cause analysis document.

### BACKGROUND

Computers can experience problems, and a cause of a problem can be identified.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can determine a resolution to an issue with a computing device. The system can, based on the determining of the resolution and a root cause analysis document template, process data relevant to the resolution to the issue with the computing device with natural language processing, to produce a root cause analysis document. The system can store the root cause analysis document. The system can update a second document based on the root cause analysis document, wherein the second document differs from the root cause analysis document.

An example method can comprise determining, by a system comprising at least one processor, a resolution to an issue with computing equipment. The method can further comprise, based on the determining of the resolution and using natural language processing, processing, by the system, data relevant to the resolution to the issue with the computing equipment, to produce root cause data representative of a root cause analysis document. The method can further comprise storing, by the system, the root cause analysis document.

An example non-transitory computer-readable medium can comprise instructions that, in response to execution, cause a system comprising a processor to perform operations. These operations can comprise determining a resolution to an issue with a computer. These operations can further comprise, based on the determining of the resolution, processing data relevant to the resolution to the issue with the computer with a natural language processing technique, to produce a root cause analysis file.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate user specific root cause analysis generation, in accordance with an embodiment of this disclosure;

FIG. 2 illustrates another example system architecture that can facilitate user specific root cause analysis generation, in accordance with an embodiment of this disclosure;

FIG. 3 illustrates another example system architecture that can facilitate user specific root cause analysis generation, in accordance with an embodiment of this disclosure;

FIG. 4 illustrates another example system architecture that can facilitate user specific root cause analysis generation, in accordance with an embodiment of this disclosure;

FIG. 5 illustrates another example system architecture where a new solution is found and used for knowledge base article enhancement, and that can facilitate user specific root cause analysis generation, in accordance with an embodiment of this disclosure;

FIG. 6 illustrates another example system architecture where a new solution is found and used for knowledge base article enhancement, and that can facilitate user specific root cause analysis generation, in accordance with an embodiment of this disclosure;

FIG. 7 illustrates another example system architecture where a new solution is found and used for knowledge base article enhancement, and that can facilitate user specific root cause analysis generation, in accordance with an embodiment of this disclosure;

FIG. 8 illustrates another example system architecture where a new solution is found and used for knowledge base article generation, and that can facilitate user specific root cause analysis generation, in accordance with an embodiment of this disclosure;

FIG. 9 illustrates another example system architecture where a new solution is found and used for knowledge base article generation, and that can facilitate user specific root cause analysis generation, in accordance with an embodiment of this disclosure;

FIG. 10 illustrates another example system architecture where a new solution is found and used for knowledge base article generation, and that can facilitate user specific root cause analysis generation, in accordance with an embodiment of this disclosure;

FIG. 11 illustrates an example process flow that can facilitate user specific root cause analysis generation, in accordance with an embodiment of this disclosure;

FIG. 12 illustrates another example process flow that can facilitate user specific root cause analysis generation, in accordance with an embodiment of this disclosure;

FIG. 13 illustrates another example process flow that can facilitate user specific root cause analysis generation, in accordance with an embodiment of this disclosure;

FIG. 14 illustrates an example block diagram of a computer operable to execute an embodiment of this disclosure.

### DETAILED DESCRIPTION

### Overview

The present techniques can generally relate to areas such as:
1. Generating automated root-cause documentation to streamline a process of documenting issues.
2. Enriching documentation with new issues, so as to keep knowledge bases up-to-date.
3. Enriching documentation with new resolutions to facilitate having the latest solutions available.

In some examples, once a user issue and a resolution are identified, there can be an expectation to deliver an executive summary and a root cause analysis (RCA).

The RCA delivery process can be complex for various reasons, such as:
It can require providing highly-detailed technical details alongside a timeline and a user-consumable explanation.
It can be that the document is not allowed to expose company-internal data.
It can be that the document should avoid using particular other terminology.

A solution to these problems with RCA delivery can comprise composing a knowledge base (KB) article (KBA) in scenarios where an issue repeats. The data in the KB article can be used as a basis for an RCA document, as it can be that the KB article has already been reviewed and aligned with the above standards.

Where a case is resolved, relevant data (e.g., a KB article number, a timeline, log messages, the impact, etc.) can be provided to a natural language processing (NLP) component to draft a corresponding RCA document.

The present techniques can be implemented to generate an automated RCA document based on related KB article(s) and case-specific information during an in-call phase.

Prior approaches generally involve manual work against KB articles to create an RCA document, incorporating technical writer review and legal review.

Consider an example where a call topic prediction mechanism has identified the user's issue and provided one (or more) resolution steps. In some cases, none of the available resolutions resolve the specific user case, which can involve additional investigation and work.

As described above, KB articles can describe a problem and specific resolutions and can be used by users for self-service support. However, once created, it can be that these are rarely altered or enhanced to include new resolution steps or details.

The present techniques can address this problem by processing RCA information provided by the support engineer and composing a resolution procedure. The information can be used to:
Enrich the KB article with the new resolution flow.
Update a common computation and storage-cloud test and performance platform (CCS-CTPP, which can generally to assess how well cloud services handle specific workloads) with the new prediction-resolution flow.

RCA document re-phrasing and alignment can be performed, similar to as described above.

The present techniques can be implemented to facilitate KB and CCS-CTPP auto-enhancement via RCA document processing. This is in contrast to prior approaches that generally involve manual KB article updating.

Where a call topic prediction mechanism has not identified a user's issue, a triage and analysis flow can be performed to determine a root cause and resolution steps.

Once complete, a support agent can be expected to create a detailed KB article that can be used for purposes such as:
Internal: A future reference in case the same issue re-occurs; and
External: A reference in case a user encounters the issue.

Creating a KB article can be complex (it can comprise writing it up, determining what information should be internal v. user visible, having a technical writer review it, etc.), so can be skipped where it is a manual process.

The present techniques can facilitate a mechanism to ingest the technical details provided during the analysis, and the RCA details provided by a support agent. The present techniques can leverage a natural language processing (NLP) model (embedded with relevant retrieval-augmented generation (RAG) modules) to create a draft KB article. A KB article can then be consumed.

The present techniques can facilitate KB article auto-creation based on real-time RCA details, and/or categorizing article contents according to visibility restrictions.

Prior approaches can generally involve manual KB article creation, categorization, and review.

### Example Architectures

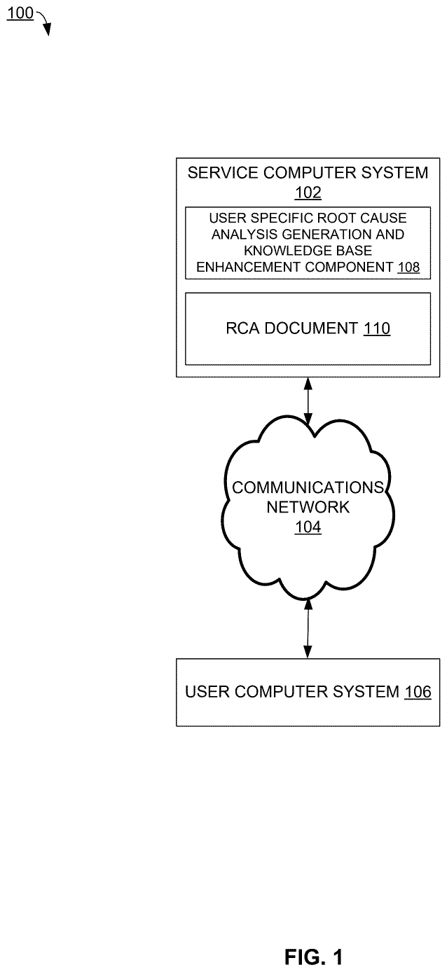

FIG. 1 illustrates an example system architecture 100 that can facilitate user specific root cause analysis generation, in accordance with an embodiment of this disclosure.

System architecture 100 comprises service computer system 102, communications network 104, and user computer system 106. Service computer system 102 comprises user specific root cause analysis generation component 108 and RCA document 110.

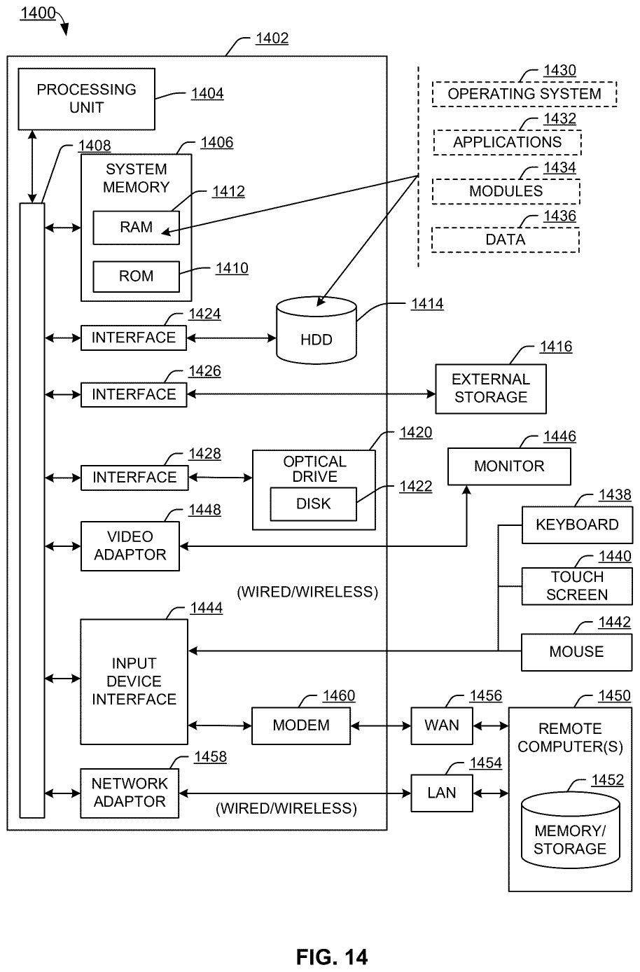

Each of service computer system 102 and/or user computer system 106 can be implemented with part(s) of computing environment 1400 of FIG. 14. Communications network 104 can comprise a computer communications network, such as the Internet.

User computer system 106 can be experiencing an issue or a problem with its operation. As part of fixing this, a support call can be made from a user associated with user computer system 106 to a support agent associated with service computer system 102. As this problem is resolved, various updates to written documentation regarding this type of issue can be made. User specific root cause analysis generation component 108 can use this information to automatically generate an RCA document, and use this new RCA document to create a corresponding knowledge base article and/or update an existing knowledge base article.

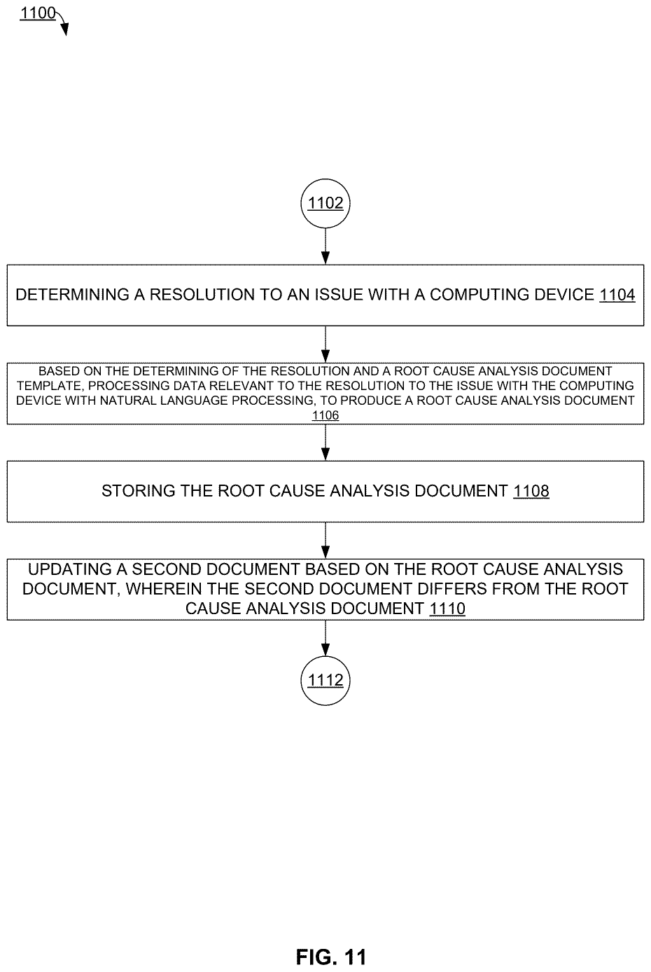

In some examples, user specific root cause analysis generation component 108 can implement part(s) of the process flows of FIGS. 11-13 to implement user specific root cause analysis generation.

It can be appreciated that system architecture 100 is one example system architecture for user specific root cause analysis generation, and that there can be other system architectures that facilitate user specific root cause analysis generation.

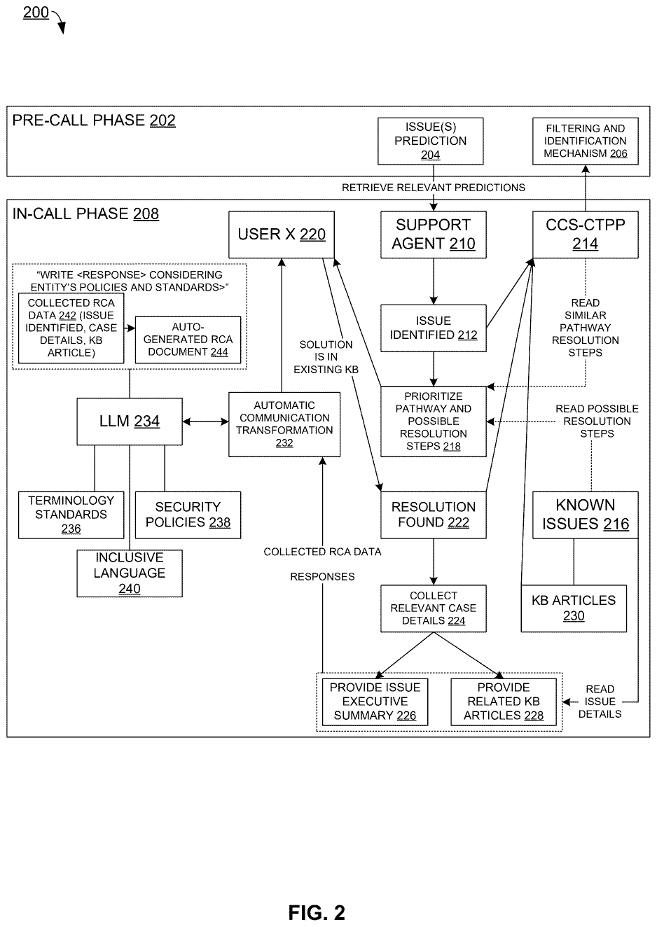

FIG. 2 illustrates another example system architecture 200 that can facilitate user specific root cause analysis generation, in accordance with an embodiment of this disclosure. In some examples, part(s) of system architecture 200 can be implemented by part(s) of system architecture 100 of FIG. 1 to facilitate user specific root cause analysis generation.

System architecture 200 comprises pre-call phase 202, issue(s) prediction 204, filtering and identification mechanism 206, in-call phase 208, support agent 210, issue identified 212, CCS-CTPP 214, known issues 216, prioritize pathway and possible resolution steps 218, user x 220, resolution found 222, collect relevant case details 224, provide issue executive summary 226, provide related KB articles 228, KB articles 230, automatic communication transformation 232, LLM 234, terminology standards 236, security policies 238, inclusive language 240, collected RCA data 242 (issue identified, case details, KB article), and auto-generated RCA document 244.

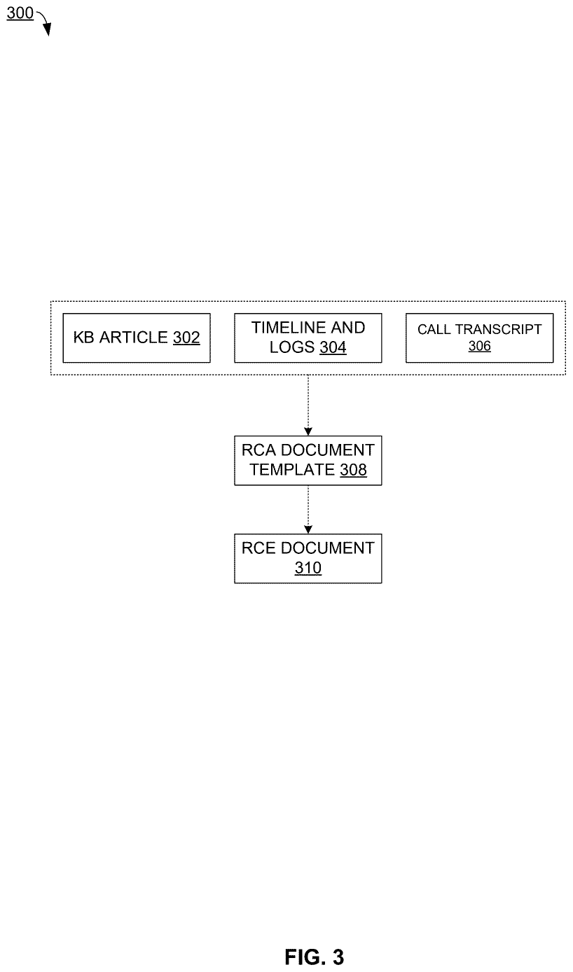

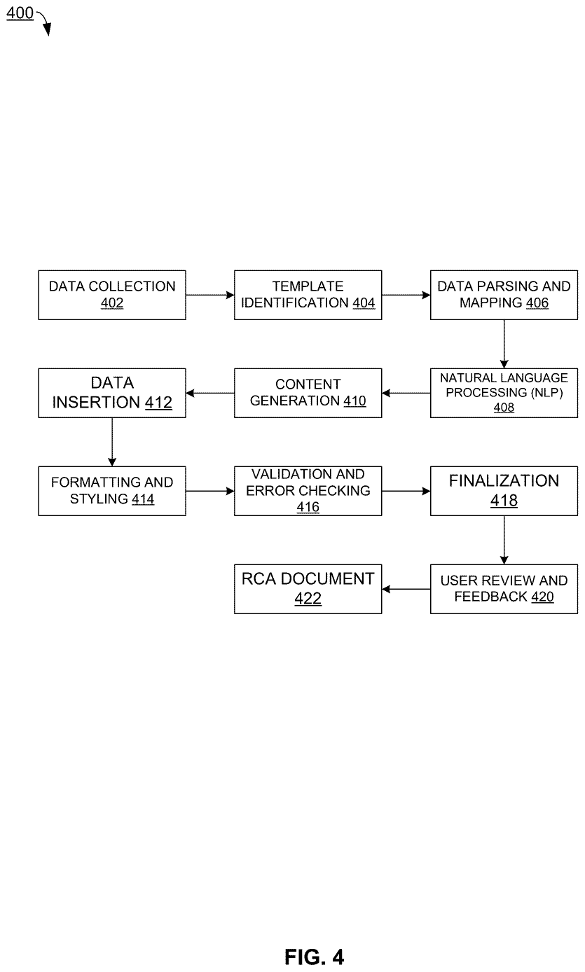

In some examples, part(s) of system architecture 200 of FIG. 2, system architecture 300 of FIG. 3, and system architecture 400 of FIG. 4 can be used together to facilitate user specific root cause analysis generation.

FIG. 3 illustrates another example system architecture 300 that can facilitate user specific root cause analysis generation, in accordance with an embodiment of this disclosure. In some examples, part(s) of system architecture 300 can be implemented by part(s) of system architecture 100 of FIG. 1 to facilitate user specific root cause analysis generation.

System architecture 300 comprises KB article 302, timeline and logs 304, call transcript 306, RCA document template 308, and RCE document 310.

In system architecture 300, information can be collected from data sources (the relevant KB article; the case specific details, such as the timeline and set of relevant log entries, and the call transcript), and this information can be transformed and fed into a document template.

FIG. 4 illustrates another example system architecture 400 that can facilitate user specific root cause analysis generation, in accordance with an embodiment of this disclosure. In some examples, part(s) of system architecture 400 can be implemented by part(s) of system architecture 100 of FIG. 1 to facilitate user specific root cause analysis generation.

System architecture 400 comprises:
Data collection 402: This can collect data to be inserted into an RCA document;
Template identification 404: This identifies the document template sections and structure;
Data parsing and mapping 406: This parses the collected data and maps it to the corresponding placeholders in the template;
Natural Language Processing (NLP) 408: If the data includes unstructured text (like user inputs), NLP techniques can be used to process and format the text appropriately. This can ensure that the text fits well within the context of the document;
Content generation 410: For sections that have generated text (e.g., summaries, introductions), this can use generative artificial intelligence (AI; gen AI) models to create coherent and contextually relevant content;
Data insertion 412: This inserts the parsed and mapped data into the placeholders in the template. This can involve ensuring that the data is correctly formatted and fits within the designated areas;
Formatting and styling 414: This applies formatting and styling so that the document looks professional and adheres to any predefined style guidelines. This can include adjusting fonts, colors, and layout elements;
Validation and error checking 416: This performs validation checks so that data has been correctly inserted and that there are no errors or inconsistencies in the document;
Finalization 418: Once the document is populated and validated, this finalizes it by saving it in a desired format (e.g., hypertext markup language (HTML) or plain text) and making it available for download or further processing;
User review and feedback 420: The final document is presented to a user account for review. Feedback can be received, and adjustments can be made; and
RCA document 422.

In some examples, other (or fewer) components can be implemented, such as creating a RCA ticket, or passing the document to legal for approval. In some examples, 402-418 can be implemented during an in-call phase of a user support interaction.

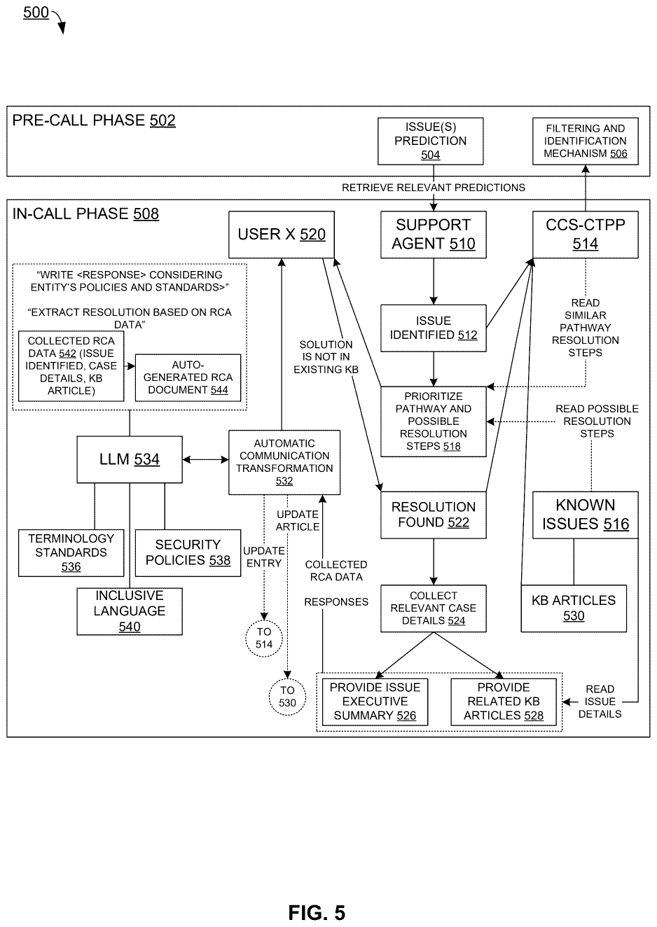

FIG. 5 illustrates another example system architecture 500 where a new solution is found and used for knowledge base article enhancement, and that can facilitate user specific root cause analysis generation, in accordance with an embodiment of this disclosure. In some examples, part(s) of system architecture 500 can be implemented by part(s) of system architecture 100 of FIG. 1 to facilitate user specific root cause analysis generation.

System architecture 500 comprises pre-call phase 502, issue(s) prediction 504, filtering and identification mechanism 506, in-call phase 508, support agent 510, issue identified 512, CCS-CTPP 514, known issues 516, prioritize pathway and possible resolution steps 518, user x 520, resolution found 522, collect relevant case details 524, provide issue executive summary 526, provide related KB articles 528, KB articles 530, automatic communication transformation 532, LLM 534, terminology standards 536, security policies 538, inclusive language 540, collected RCA data 542 (issue identified, case details, KB article), and auto-generated RCA document 544.

Relative to system architecture 200 of FIG. 2, system architecture 500 can implement different operations - an additional prompt of “extract resolution based on RCA data”, read issue details, solution is not in existing KB, update entry, and update article.

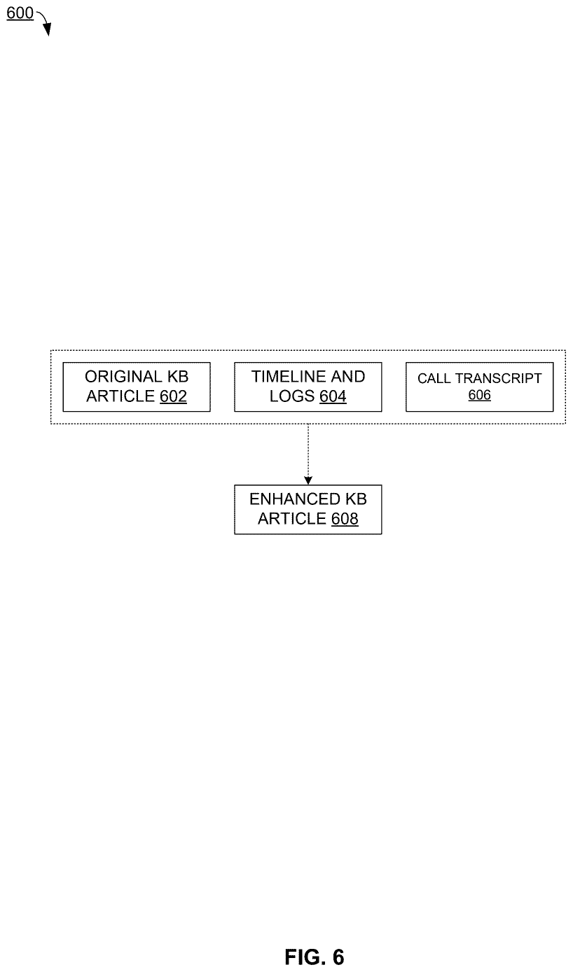

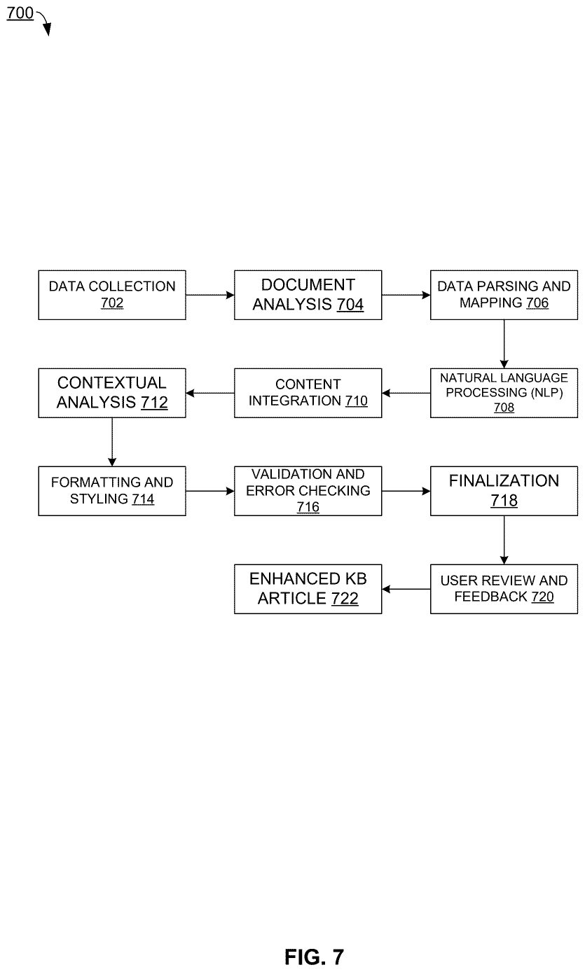

In some examples, part(s) of system architecture 500 of FIG. 5, system architecture 600 of FIG. 6, and system architecture 700 of FIG. 7 can be used together to facilitate finding a new solution, and using this new solution for enhancing a knowledge base article.

FIG. 6 illustrates another example system architecture 600 where a new solution is found and used for knowledge base article enhancement, and that can facilitate user specific root cause analysis generation, in accordance with an embodiment of this disclosure. In some examples, part(s) of system architecture 600 can be implemented by part(s) of system architecture 100 of FIG. 1 to facilitate user specific root cause analysis generation.

System architecture 600 comprises original KB article 602, timeline and logs 604, call transcript 606, and enhanced KB article 608.

In system architecture 600, information can be collected from data sources (the relevant KB article; the case specific details, such as the timeline and set of relevant log entries, and the call transcript), and this information can be transformed and used to enhance an existing KB article.

FIG. 7 illustrates another example system architecture 700 where a new solution is found and used for knowledge base article enhancement, and that can facilitate user specific root cause analysis generation, in accordance with an embodiment of this disclosure. In some examples, part(s) of system architecture 700 can be implemented by part(s) of system architecture 100 of FIG. 1 to facilitate user specific root cause analysis generation.

System architecture 700 comprises:
Data collection 702: new data provided by a user account can be gathered;
Document analysis 704: The existing document is analyzed to understand its structure, content, and context;
Data parsing and mapping 706: This parses the new data and maps it to the relevant sections of the existing document;
Natural Language Processing (NLP) 708: If the new data includes unstructured text, this uses NLP techniques to process and format the text. This can ensure that the new content is coherent and fits seamlessly into the existing document.
Content integration 710: The new data is integrated into the existing document. This can involve inserting text, updating tables, adding images, or modifying existing content to reflect the new information.
Context adjustments 712: Contextual adjustments are made so that the new data is relevant and enhances the document. This can involve rephrasing sentences, updating references, or adding explanatory notes.
Formatting and styling 714: Formatting and styling is applied to the new content to match the existing document's style. This can include adjusting fonts, colors, and layout elements to ensure a consistent look and feel.
Validation and error checking 716: Validation checks can be performed to ensure that the new data has been correctly integrated and that there are no errors or inconsistencies. This can help maintain the document's accuracy and quality.
Finalization 718: Once the document is enriched and validated, this finalizes it by saving it in a desired format (e.g., hypertext markup language (HTML) or plain text) and making it available for download or further processing;
User review and feedback 720: The enriched document is presented to a user account for review. Feedback can be received, and adjustments can be made; and
Enhanced KB article 722.

In some examples, other (or fewer) components can be implemented, such as creating a KBA ticket, or passing the document to technical writers and/or technical subject matter experts (SMEs) for approval. In some examples, 702-718 can be implemented during an in-call phase of a user support interaction.

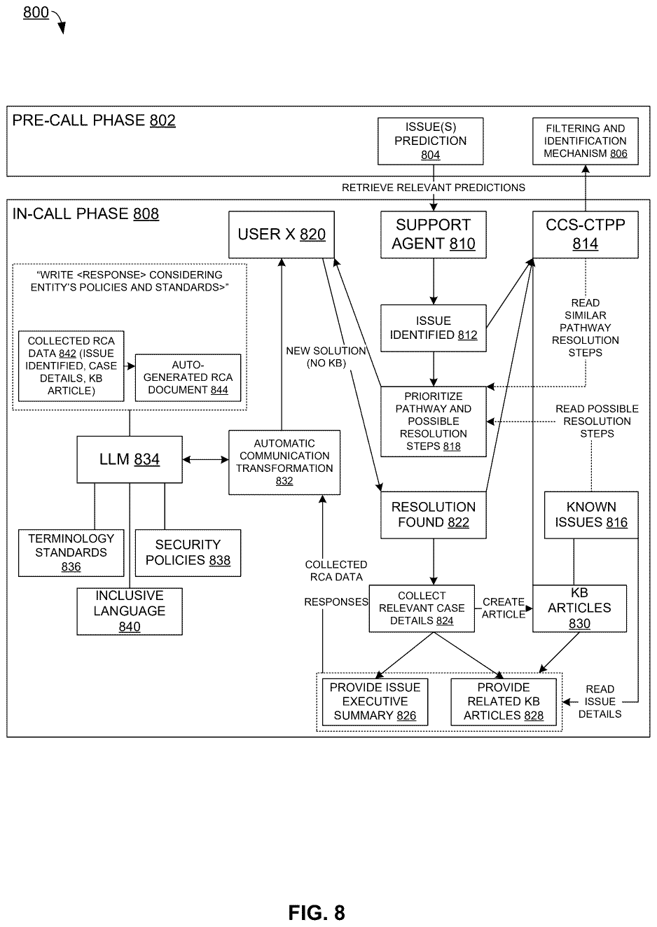

FIG. 8 illustrates another example system architecture 800 where a new solution is found and used for knowledge base article generation, and that can facilitate user specific root cause analysis generation, in accordance with an embodiment of this disclosure. In some examples, part(s) of system architecture 800 can be implemented by part(s) of system architecture 100 of FIG. 1 to facilitate user specific root cause analysis generation.

System architecture 800 comprises pre-call phase 802, issue(s) prediction 804, filtering and identification mechanism 806, in-call phase 808, support agent 810, issue identified 812, CCS-CTPP 814, known issues 816, prioritize pathway and possible resolution steps 818, user x 820, resolution found 822, collect relevant case details 824, provide issue executive summary 826, provide related KB articles 828, KB articles 830, automatic communication transformation 832, LLM 834, terminology standards 836, security policies 838, inclusive language 840, collected RCA data 842 (issue identified, case details, KB article), and auto-generated RCA document 844.

Relative to system architecture 500 of FIG. 5, system architecture 800 can implement different operations (create article, and new solution (no KB)) and omit other operations (update entry, and update article).

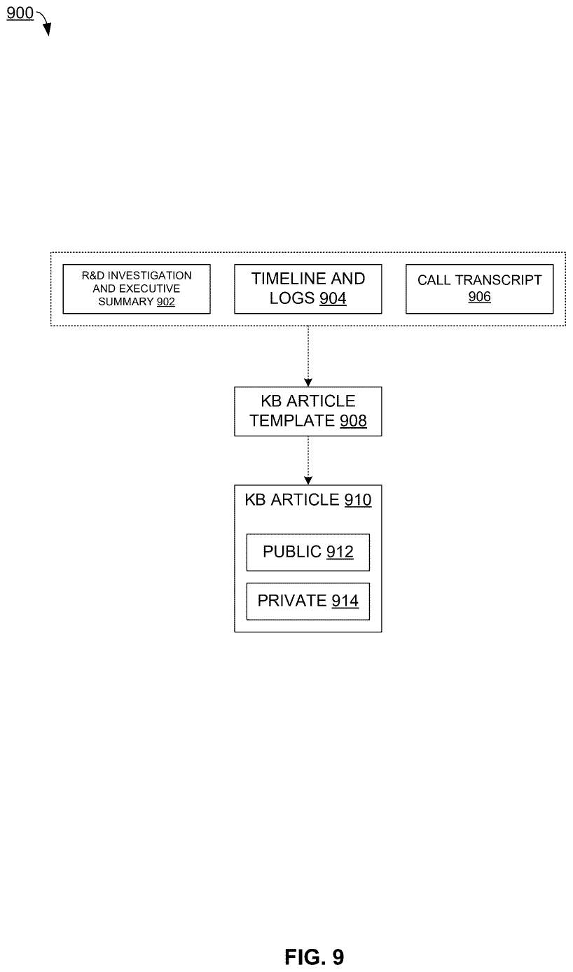

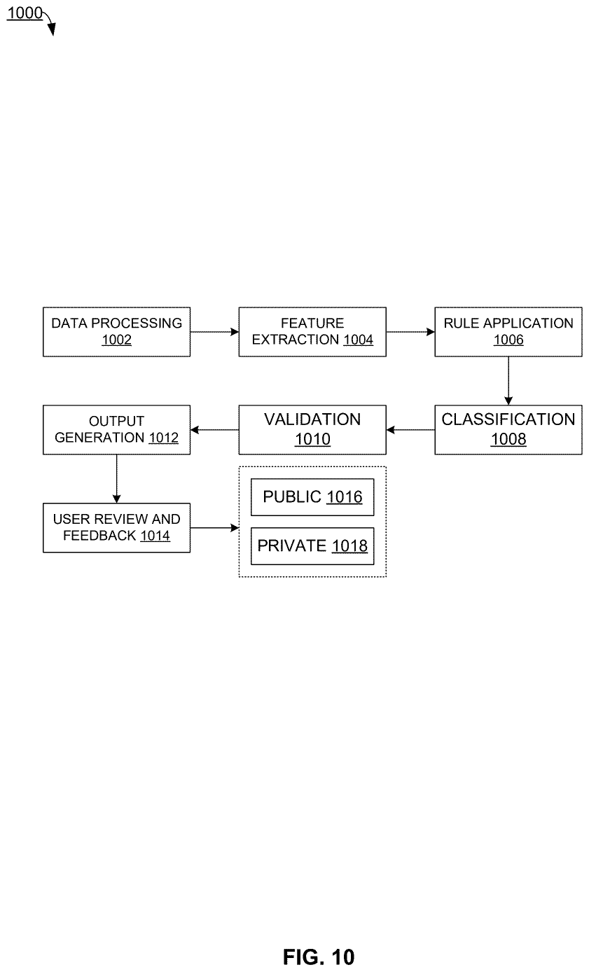

In some examples, part(s) of system architecture 800 of FIG. 8, system architecture 900 of FIG. 9, and system architecture 1000 of FIG. 10 can be used together to facilitate finding a new solution, and using this new solution for generating a knowledge base article.

FIG. 9 illustrates another example system architecture 900 where a new solution is found and used for knowledge base article generation, and that can facilitate user specific root cause analysis generation, in accordance with an embodiment of this disclosure. In some examples, part(s) of system architecture 900 can be implemented by part(s) of system architecture 100 of FIG. 1 to facilitate user specific root cause analysis generation.

System architecture 900 comprises research and development (R&D) investigation and executive summary 902, timeline and logs 904, call transcript 906, KB article template 908, KB article 910, public 912, and private 914.

In system architecture 900, information can be collected from data sources (The R&D internal noted and executive summary; the case specific details, such as the timeline and set of relevant log entries, and the call transcript), and this information can be transformed and fed into a document template.

A difference between KB article generation and RCA document generation can be in separating private information (e.g., that which should be exposed only to internal personnel) from public information that can be shared with the public.

This can facilitate auto creation of a KB article by using in-call data (e.g., agent-user call) and ticketing system data (agent and research-and-development interactions). The present techniques can facilitate classifying data arriving from R&D to know which data should presented as public or private in the KB article.

FIG. 10 illustrates another example system architecture 1000 where a new solution is found and used for knowledge base article generation, and that can facilitate user specific root cause analysis generation, in accordance with an embodiment of this disclosure. In some examples, part(s) of system architecture 1000 can be implemented by part(s) of system architecture 100 of FIG. 1 to facilitate user specific root cause analysis generation.

System architecture 1000 comprises:
Data preprocessing 1002: Preprocess the data so that it is in a suitable format for classification. This can involve cleaning the data, handling missing values, normalizing numerical values, converting text to a standard format, etc.
Feature extraction 1004: Extract relevant features from the data based on the user-provided rules. Features can comprise specific attributes or characteristics of the data that are used for classification.
Rule application 1006: Apply user-provided rules to the extracted features. This can comprise evaluating each data point against criteria defined in the rules to determine its classification.
Classification 1008: Based on the rule evaluation, assign each data point to a specific category or class. This can involve labeling the data according to the rules.
Validation and error checking 1010: Perform validation checks to ensure that the data has been correctly classified. This can help identify any misclassifications or inconsistencies.
Output generation 1012: Generate the classified data as output.
User review and feedback 1014: The classified data is presented to a user account for review. Adjustments can be made based on feedback.
Public 1016: This comprises a portion of a resulting KB article that is marked public, so can be presented to external user accounts.
Private 1018: This comprises a portion of a resulting KB article that is marked private, so is not presented to external user accounts.

In some examples, 1002-1012 can be implemented during an in-call phase of a user support interaction.

### Example Procss Flows

FIG. 11 illustrates an example process flow 1100 that can facilitate user specific root cause analysis generation, in accordance with an embodiment of this disclosure. In some examples, one or more embodiments of process flow 1100 can be implemented by user specific root cause analysis generation component 108 of FIG. 1, or computing environment 1400 of FIG. 14.

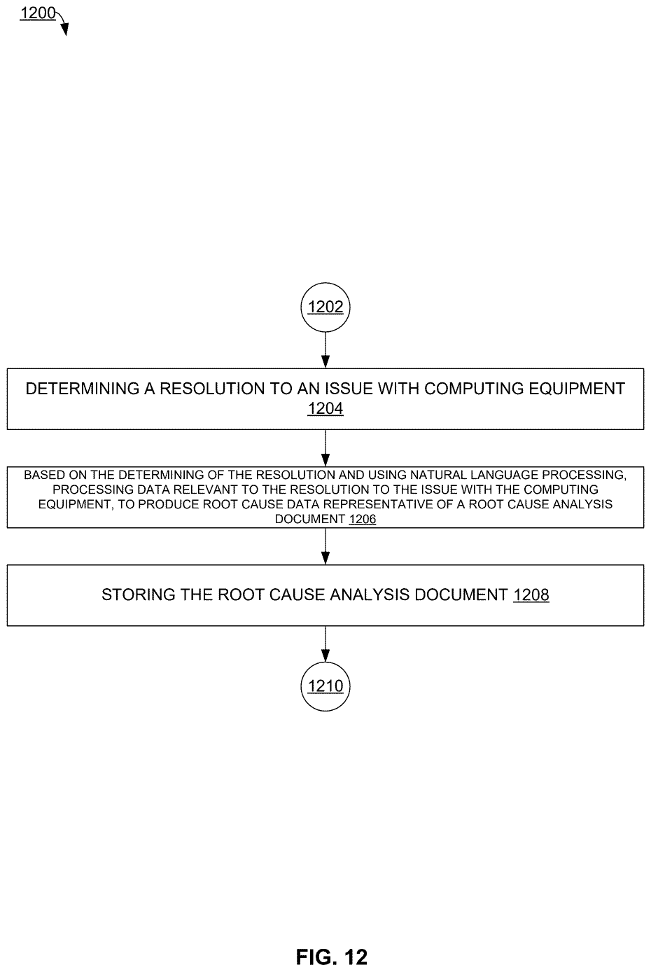

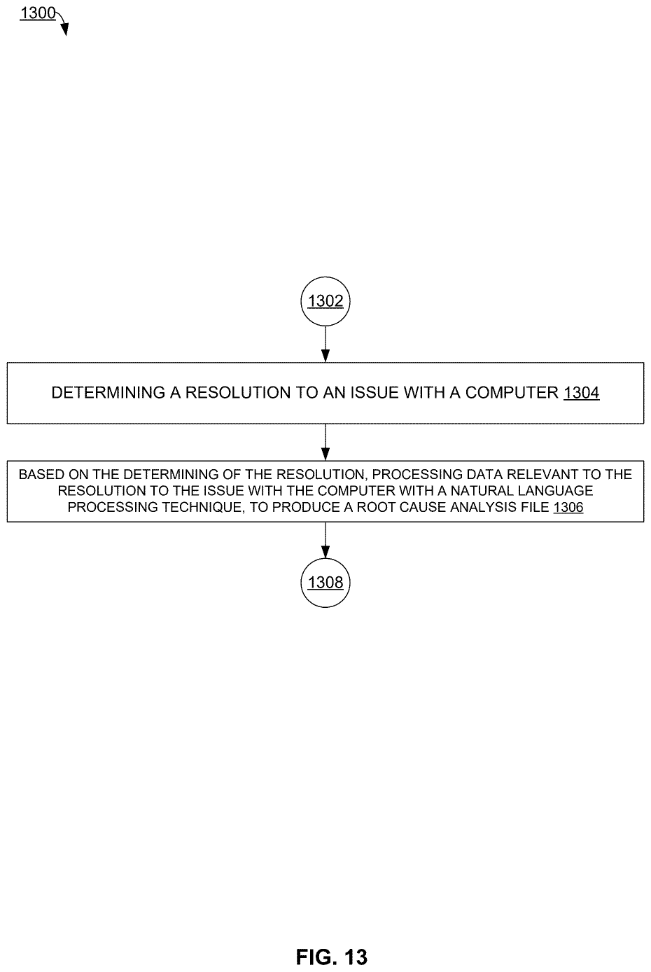

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 1200 of FIG. 12, and/or process flow 1300 of FIG. 13.

Process flow 1100 begins with 1102, and moves to operation 1104.

Operation 1104 depicts determining a resolution to an issue with a computing device.

After operation 1104, process flow 1100 moves to operation 1106. That is, there can be an issue or problem with operation of a computer, a support call to a vendor of the computer can be made to address the issue, and as part of the support call a resolution or fix to the issue can be identified (e.g., to apply a software patch to an application of the computer, or to change a configuration setting of the computer).

Operation 1106 depicts, based on the determining of the resolution and a root cause analysis document template, processing data relevant to the resolution to the issue with the computing device with natural language processing, to produce a root cause analysis document. This can be performed in a similar manner as described with respect FIGS. 2-4.

In some examples, the data relevant to the resolution to the issue with the computing device comprises an identifier of a knowledge base article. In some examples, the identifier of the knowledge base article comprises a knowledge base article number.

In some examples, the data relevant to the resolution to the issue with the computing device comprises a timeline of events regarding the issue with the computing device. In some examples, the data relevant to the resolution to the issue with the computing device comprises log messages regarding the issue with the computing device. In some examples, the data relevant to the resolution to the issue with the computing device comprises an identification of an impact of the issue with the computing device.

That is, where an issue is resolved, relevant data, such as KB article number, a timeline, log messages, the exact impact, etc., can be provided to a generative AI component (e.g., one that implements natural language processing techniques) to draft a root cause analysis document.

After operation 1106, process flow 1100 moves to operation 1108.

Operation 1108 depicts storing the root cause analysis document. That is, once generated in operation 1106, a root cause analysis document can be stored in a computer memory and made available for later access.

After operation 1108, process flow 1100 moves to operation 1110.

Operation 1110 depicts updating a second document based on the root cause analysis document, wherein the second document differs from the root cause analysis document. This can be performed in a similar manner as FIGS. 5-7 (generating a KBA) and/or FIGS. 8-10 (enhancing an existing KBA).

In some examples, the updating of the second document based on the root cause analysis document comprises, after the producing of the root cause analysis document, updating a knowledge base article that corresponds to the issue with the computing device with a resolution flow identified in the root cause analysis document, wherein the second document comprises the knowledge base article. That is, the RCA document can be used to enrich an existing KB article with a new resolution flow, where one has been identified.

In some examples, the updating of the second document based on the root cause analysis document comprises, after the producing of the root cause analysis document, updating a common computation and storage cloud test and performance platform with a prediction-resolution flow identified in the root cause analysis document, wherein the common computation and storage cloud test and performance platform comprises the second document. In some examples, the common computation and storage cloud test and performance platform is configured to assess a defined metric relating to a performance of a cloud service when handling at least one specified workload. That is, a CCS-CTPP can be updated with a new prediction resolution flow where one is identified in an RCA document.

After operation 1110, process flow 1100 moves to 1112, where process flow 1100 ends.

FIG. 12 illustrates another example process flow 1200 that can facilitate user specific root cause analysis generation, in accordance with an embodiment of this disclosure. In some examples, one or more embodiments of process flow 1200 can be implemented by user specific root cause analysis generation component 108 of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 1100 of FIG. 11, and/or process flow 1300 of FIG. 13.

Process flow 1200 begins with 1202, and moves to operation 1204.

Operation 1204 depicts determining a resolution to an issue with computing equipment. In some examples, operation 1204 can be implemented in a similar manner as operation 1104 of FIG. 11.

After operation 1204, process flow 1200 moves to operation 1206.

Operation 1206 depicts, based on the determining of the resolution and using natural language processing, processing data relevant to the resolution to the issue with the computing equipment, to produce root cause data representative of a root cause analysis document. In some examples, operation 1206 can be implemented in a similar manner as operation 1106 of FIG. 11.

After operation 1206, process flow 1200 moves to operation 1208.

Operation 1208 depicts storing the root cause analysis document. In some examples, operation 1208 can be implemented in a similar manner as operation 1108 of FIG. 11.

In some examples, operation 1208 comprises creating article data representative of a knowledge base article based on using the natural language processing on the root cause data. In some examples, the creating of the article data is performed based on at least part of the root cause data that satisfies a defined real-time criterion. In some examples, operation 1208 comprises processing the article data to categorize first content of the knowledge base article based on at least one visibility restriction relevant to second content of the knowledge base article. That is, a KB article can be created based on real-time RCA details.

In some examples, the processing of the data relevant to the resolution to the issue with the computing equipment using the natural language processing occurs during an in-call phase of a service call related to the issue with the computing equipment. That is, this can occur while a corresponding support call is occurring.

After operation 1208, process flow 1200 moves to 1210, where process flow 1200 ends.

FIG. 13 illustrates another example process flow 1300 that can facilitate user specific root cause analysis generation, in accordance with an embodiment of this disclosure. In some examples, one or more embodiments of process flow 1300 can be implemented by user specific root cause analysis generation component 108 of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 1100 of FIG. 11, and/or process flow 1200 of FIG. 12.

Process flow 1300 begins with 1302, and moves to operation 1304.

Operation 1304 depicts determining a resolution to an issue with a computer. In some examples, operation 1304 can be implemented in a similar manner as operation 1104 of FIG. 11.

After operation 1304, process flow 1300 moves to operation 1306.

Operation 1306 depicts based on the determining of the resolution, processing data relevant to the resolution to the issue with the computer with a natural language processing technique, to produce a root cause analysis file. In some examples, operation 1306 can be implemented in a similar manner as operation 1106 of FIG. 11.

In some examples, the data relevant to the resolution to the issue with the computer comprises a transcript or recording of a voice call that addresses the issue with the computer. This can be similar to call transcript 306 of FIG. 3, call transcript 606 of FIG. 6, and/or call transcript 906 of FIG. 9.

In some examples, a retrieval-augmented generation system implements the natural language processing technique, and the retrieval-augmented generation system is configured to access first data representative of terminology standards, second data representative of security policies, or third data representative of inclusive language. This can be similar to LLM 234 of FIG. 2, which accesses terminology standards 236, security policies 238, inclusive language 240, and collected RCA data 242 (issue identified, case details, KB article), and/or similar portions of FIGS. 5 and 8.

In some examples, a generative artificial intelligence system implements the natural language processing technique, and operation 1306 comprises prompting the generative artificial intelligence system with a natural-language prompt that indicates a request to produce the root cause analysis file. This can be similar to “write <response> considering entity's policies and standards>” of FIG. 2.

In some examples, the data relevant to the resolution to the issue with the computer comprises a knowledge base article, and wherein the knowledge base article comprises information, an instruction, or a solution that relates to the issue with the computer.

In some examples, the root cause analysis file comprises a first identification of the issue with the computer, and a second identification of a fundamental cause of the issue with the computer or at least one underlying factor that contributed to manifestation of the issue with the computer.

After operation 1306, process flow 1300 moves to 1308, where process flow 1300 ends.

### Example Operating Environment

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of service computer system 102, and/or user computer system 106.

In some examples, computing environment 1400 can implement one or more embodiments of the process flows of FIGS. 11-13 to facilitate user specific root cause analysis generation.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1020 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1020 can be connected to the system bus 1408 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1044 that can be coupled to the system bus 1408, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1408 via an interface, such as a video adapter 1048. In addition to the monitor 1046, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1060 or can be connected to a communications server on the WAN 1456 via other means for establishing communications over the WAN 1456, such as by way of the Internet. The modem 1060, which can be internal or external and a wired or wireless device, can be connected to the system bus 1408 via the input device interface 1044. In a networked environment, program modules depicted relative to the computer 1402 or portions thereof, can be stored in the remote memory/storage device 1452. It will be appreciated that the network connections shown are examples, and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1060, respectively. Upon connecting the computer 1402 to an associated cloud storage system, the external storage interface 1026 can, with the aid of the adapter 1458 and/or modem 1060, manage storage provided by the cloud storage system as it would other types of external storage. For instance, the external storage interface 1026 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
determining a resolution to an issue with a computing device;
based on the determining of the resolution and a root cause analysis document template, processing data relevant to the resolution to the issue with the computing device with natural language processing, to produce a root cause analysis document;
storing the root cause analysis document; and
updating a second document based on the root cause analysis document, wherein the second document differs from the root cause analysis document.

2. The system of claim 1, wherein the data relevant to the resolution to the issue with the computing device comprises an identifier of a knowledge base article.

3. The system of claim 2, wherein the identifier of the knowledge base article comprises a knowledge base article number.

4. The system of claim 1, wherein the data relevant to the resolution to the issue with the computing device comprises a timeline of events regarding the issue with the computing device.

5. The system of claim 1, wherein the data relevant to the resolution to the issue with the computing device comprises log messages regarding the issue with the computing device.

6. The system of claim 1, wherein the data relevant to the resolution to the issue with the computing device comprises an identification of an impact of the issue with the computing device.

7. The system of claim 1, wherein the updating of the second document based on the root cause analysis document comprises:
after the producing of the root cause analysis document, updating a knowledge base article that corresponds to the issue with the computing device with a resolution flow identified in the root cause analysis document, wherein the second document comprises the knowledge base article.

8. The system of claim 1, wherein the updating of the second document based on the root cause analysis document comprises:
after the producing of the root cause analysis document, updating a common computation and storage cloud test and performance platform with a prediction-resolution flow identified in the root cause analysis document, wherein the common computation and storage cloud test and performance platform comprises the second document.

9. The system of claim 8, wherein the common computation and storage cloud test and performance platform is configured to assess a defined metric relating to a performance of a cloud service when handling at least one specified workload.

10. A method, comprising:
determining, by a system comprising at least one processor, a resolution to an issue with computing equipment;
based on the determining of the resolution and using natural language processing, processing, by the system, data relevant to the resolution to the issue with the computing equipment, to produce root cause data representative of a root cause analysis document; and
storing, by the system, the root cause analysis document.

11. The method of claim 10, further comprising:
creating, by the system, article data representative of a knowledge base article based on using the natural language processing on the root cause data.

12. The method of claim 11, wherein the creating of the article data is performed based on at least part of the root cause data that satisfies a defined real-time criterion.

13. The method of claim 11, further comprising:
processing, by the system, the article data to categorize first content of the knowledge base article based on at least one visibility restriction relevant to second content of the knowledge base article.

14. The method of claim 11, wherein the processing of the data relevant to the resolution to the issue with the computing equipment using the natural language processing occurs during an in-call phase of a service call related to the issue with the computing equipment.

15. A non-transitory computer-readable medium comprising instructions that, in response to execution, cause a system comprising at least one processor to perform operations, comprising:
determining a resolution to an issue with a computer; and
based on the determining of the resolution, processing data relevant to the resolution to the issue with the computer with a natural language processing technique, to produce a root cause analysis file.

16. The non-transitory computer-readable medium of claim 15, wherein the data relevant to the resolution to the issue with the computer comprises a transcript or recording of a voice call that addresses the issue with the computer.

17. The non-transitory computer-readable medium of claim 15, wherein a retrieval-augmented generation system implements the natural language processing technique, and wherein the retrieval-augmented generation system is configured to access first data representative of terminology standards, second data representative of security policies, or third data representative of inclusive language.

18. The non-transitory computer-readable medium of claim 15, wherein a generative artificial intelligence system implements the natural language processing technique, and wherein the operations further comprise:
prompting the generative artificial intelligence system with a natural-language prompt that indicates a request to produce the root cause analysis file.

19. The non-transitory computer-readable medium of claim 15, wherein the data relevant to the resolution to the issue with the computer comprises a knowledge base article, and wherein the knowledge base article comprises information, an instruction, or a solution that relates to the issue with the computer.

20. The non-transitory computer-readable medium of claim 15, wherein the root cause analysis file comprises a first identification of the issue with the computer, and a second identification of a fundamental cause of the issue with the computer or at least one underlying factor that contributed to manifestation of the issue with the computer.
